(19) United States
(12) Patent Application Publication
(10) Pub. No.: US 2003/0145055 A1
(43) Pub. Date: Jul. 31, 2003

(54) Method for delivering data to, and processing data in, a data processing unit

(76) Inventor: Michael Henke, Weilheim (DE)

Correspondence Address: BELL, BOYD & LLOYD, LLC, P. O. BOX 1135, CHICAGO, IL, 60690-1135, US

(21) Appl. No.: 10/318,651

(22) Filed: Dec. 12, 2002

(30) Foreign Application Priority Data
Dec. 12, 2001 (DE) 101 61 034.3

(51) Int. Cl. G06F 15/16

(52) U.S. Cl. 709/205

(57) ABSTRACT

A method is provided for delivering and processing data subsets from a number of sources to/in a central data processing unit. The data subsets are transferred via an internet interface to the central data processing unit and stored there. The data subsets from different sources are processed to form a shared program and the program is stored in a central memory. The program can be transferred and read using the internet interface. Data concerning the status of the data processing operation in its current updated form is signaled via the internet interface and/or reported back to the sources via a message communication system/service.

### BACKGROUND OF THE INVENTION

Major software developments are currently carried out by a number of software development teams. In this process, one sub-component is developed by each team. These teams are often based at different locations, and in different parts of the world. The developed sub-components have to be transferred to a central production unit which processes these into a shared program.

The project manager and teams have to be informed about deliveries so they can initiate production requests, coordinate delivered modifications and continue further developments without delay. Also, the production results have to be easily available and retrievable for all participants.

Until now the development teams sent the central production unit e-mails containing the sub-components with a jointly agreed code. The central production unit produced the shared software on the basis of e-mails received and production requests received by telephone or e-mail.

Production results were also circulated to participants by e-mail. It was then left up to each participant to exchange information and keep a history of the e-mail traffic.

In practice, problems occurred with version migrations of the e-mail tools used. Deliveries could only be assigned in e-mail catalog structures, in order to maintain an overview of, for example, 20 projects each with approximately 500 deliveries.

New software versions of the e-mail tool used were frequently incompatible with the old organizational structure. E-mails either could not be read or were destroyed (data loss). Data loss also occurred as a result of lost or incorrectly sent e-mails.

The data flow was very restricted, as generally only the sender and the recipient were in e-mail contact. Third parties often only could get an overview of activities by telephone. The central production unit was unable to display its current operations, so a significant amount of working time had to be spent giving information by telephone.

An object of the present invention is to implement an organized, secure, platform-independent method for delivering data subsets, such as source code, to a shared data processing unit, to make the shared data processing unit results available and to signal data concerning the status of the data processing operation in its current updated form.

### SUMMARY OF THE INVENTION

Accordingly, in an embodiment of the present invention, a method is provided for delivering data subsets from a number of sources to, and processing the data subsets in, a central data processing unit, wherein the data subsets are transferred via an internet interface to the central data processing unit and stored there, the data subsets from different sources are processed to form a shared program, the shared program is stored in a central memory and can be transferred and read using the internet interface, and data concerning the status of the data processing operation in its current updated form is signaled via the internet interface and/or reported back via a message communication system/service to the sources.

In an embodiment, the message communication system/service is an e-mail service.

In an embodiment, the internet interface has retrievable forms.

In an embodiment, the stored data subsets and/or the stored programs are searched and/or filtered using key words and the results of the search and/or filter operation are displayed.

Advantages achieved with the present invention, in particular, include the fact that secure, organized, platform-independent delivery and supply of data, such as source code, are available and the program data stored in a central memory is automatically available to the user group in its current updated form and can be signaled simply.

Additional features and advantages of the present invention are described in, and will be apparent from, the following Detailed Description of the Invention and the Figures.

### BRIEF DESCRIPTION OF THE FIGURES

FIG. 1 shows a block circuit diagram of an arrangement for implementing the method of the present invention.

### DETAILED DESCRIPTION OF THE INVENTION

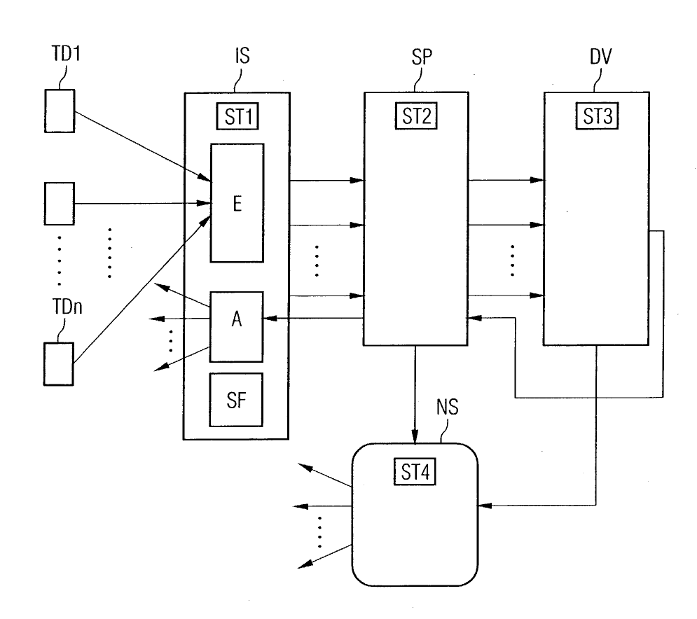

FIG. 1 shows the basic principles of the structure of an arrangement for implementing the method according to the present invention. Data subsets TD1, . . . , TDn, which are prepared by teams (not shown) are transferred to an internet interface IS and forwarded on the recipient side to a memory SP and a central data processing unit DV. There is also a message communication system NS, which sends messages back to the teams (not shown).

The data subset TD is transferred via internet links to the internet interface IS. The internet interface has a form; for example, in HTML technology. This form can be used to deliver the individual data subset TD, such as source code or identifiers, for example. If required, a plausibility and/or error check can be carried out on the delivered data subset TD; for example, via CGI script technology. The delivered data is then stored in a central memory SP, If required, further data can be added to the stored data subset TD, such as, for example, software identifier, software component, ID, time of delivery, etc. Participants are automatically informed after a delivery by the message communication system; for example, by e-mail.

When all the necessary subcomponents have been delivered, production of a shared program can be initiated in the data processing unit. To do this, a menu is used to select data subsets for production. A further plausibility and error check can be carried out on the selected data subset; for example, using CGI script technology. The selected data subset is processed to a shared program by the data processing unit DV. This program is stored in the central memory SP and can be read by users via the internet interface IS. Also data concerning the status of the data processing operation in its current updated form is signaled via the internet interface IS; such as in HTML technology, and by the message communication system NS; for example, by e-mails to the teams or participants.

It is also possible to search the databases using key words. The internet interface IS has a further form for this purpose, such as in HTML technology, in which search words and search options can be input or selected.

By filtering the data in the central memory SP, such as by using CGI script technology, data can be selected, displayed or read.

The internet interface IS, the central memory SP, the data processing unit DV and the message communication system NS each have a control unit ST1, . . . , ST4 to carry out the described actions.

Although the present invention has been described with reference to specific embodiments, those of skill in the art will recognize that changes may be made thereto without departing from the spirit and scope of the present invention as set forth in the hereafter appended claims.

1. A method for delivering data subsets from a plurality of sources to, and processing the data subsets in, a central data processing unit, the method comprising the steps of:
transferring the data subsets via an internet interface to the central data processing unit;
storing the data subsets in a central data processing unit;
processing the data subsets from different sources to form a shared program;
storing the shared program in a central memory;
using the internet interface to transfer and read the shared program; and
enabling data concerning a status of the data processing operation in a current updated form to be at least one of signaled via the internet interface and reported back via a message communication system/service to the plurality of sources.

2. A method for delivering and processing data subsets as claimed in claim 1, wherein the message communication system/service is an e-mail service.

3. A method for delivering and processing data subsets as claimed in claim 1, wherein the internet interface has retrievable forms.

4. A method for delivering and processing data subsets as claimed in claim 1, wherein the method further includes at least one of the steps of searching and filtering at least one of the stored data subsets and the stored programs using key words, with results then being displayed.
